(19) United States
(12) Patent Application Publication
(10) Pub. No.: US 2013/0163794 A1
(43) Pub. Date: Jun. 27, 2013

(54) DYNAMIC CONTROL OF AUDIO ON A MOBILE DEVICE WITH RESPECT TO ORIENTATION OF THE MOBILE DEVICE

(71) Applicants: William R. Groves, Naperville, IL (US); Roger W. Ady, Chicago, IL (US); Giles T. Davis, Mundelein, IL (US)

(72) Inventors: William R. Groves, Naperville, IL (US); Roger W. Ady, Chicago, IL (US); Giles T. Davis, Mundelein, IL (US)

(73) Assignee: MOTOROLA MOBILITY, INC., Libertyville, IL (US)

(21) Appl. No.: 13/334,096

(22) Filed: Dec. 22, 2011

(51) Int. Cl. H04R 5/02

(52) U.S. Cl. 381/303; 381/300

(57) ABSTRACT

A method of optimizing audio performance of a mobile device. The method can include detecting an orientation of the mobile device. The method also can include, via a processor, responsive to the mobile device being oriented in a first orientation, dynamically selecting at least a first output audio transducer to output left channel audio signals and dynamically selecting at least a second output audio transducer to output right channel audio signals. The method further can include communicating the left channel audio signals to the first output audio transducer and communicating the right channel audio signals to the second output audio transducer.

### BACKGROUND OF THE INVENTION

1. Field of the Invention

The present invention generally relates to mobile devices and, more particularly, to generating audio information on a mobile device.

2. Background of the Invention

The use of mobile devices, for example smart phones, tablet computers and mobile gaming devices, is prevalent throughout most of the industrialized world. Mobile devices commonly are used to present media, such as music and other audio media, multimedia presentations that include both audio media and image media, and games that generate audio media. A typical mobile device may include one or two output audio transducers (e.g., loudspeakers) to generate audio signals related to the audio media. Mobile devices that include two speakers sometimes are configured to present audio signals as stereophonic signals.

### BRIEF DESCRIPTION OF THE DRAWINGS

Preferred embodiments of the present invention will be described below in more detail, with reference to the accompanying drawings, in which:

FIGS. 1a-1d depict a front view of a mobile device in various orientations, which are useful for understanding the present invention;

FIGS. 2a-2d depict a front view of another embodiment of the mobile device of FIG. 1, in various orientations;

FIGS. 3a-3d depict a front view of another embodiment of the mobile device of FIG. 1, in various orientations;

FIGS. 4a-4d depict a front view of another embodiment of the mobile device of FIG. 1, in various orientations;

FIG. 5 is a block diagram of the mobile device that is useful for understanding the present arrangements;

FIG. 6 is a flowchart illustrating a method that is useful for understanding the present arrangements; and

FIG. 7 is a flowchart illustrating a method that is useful for understanding the present arrangements.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to the use of two or more speakers on a mobile device to present audio media using stereophonic (hereinafter “stereo”) audio signals. Mobile devices oftentimes are configured so that they can be rotated from a landscape orientation to a portrait orientation, rotated in a top-side down orientation, etc. In a typical mobile device with stereo capability, a first output audio transducer (e.g., loudspeakers) located on a left side of the mobile device is dedicated to left channel audio signals, and a second output audio transducer located on a right side of the mobile device is dedicated to right channel audio signals. Thus, if the mobile device is rotated from a landscape orientation to a portrait orientation, the first and second speakers may be vertically aligned, thereby adversely affecting stereo separation and making it difficult for a user to discern left and right channel audio signals information. Moreover, if the mobile device is oriented top side-down, the right and left sides of the mobile device are reversed, thus reversing the left and right audio channels.

The present arrangements address these issues by dynamically selecting which output audio transducer(s) are used to output right channel audio signals and which output audio transducer(s) are used to output left channel audio signals based on the orientation of the mobile device. Specifically, the present arrangement provide that at least one left-most output audio transducer, with respect to a user, presents left channel audio signals and at least one output audio transducer, with respect to the user, presents right channel audio signals. Accordingly, the present invention maintains proper stereo separation of output audio signals, regardless of the position in which the mobile device is oriented. Further, in an arrangement in which the mobile device includes three or more output audio transducers, one or more output audio transducers can be dynamically selected to exclusively output bass frequencies of the audio media.

Moreover, the present arrangements also can dynamically select which input audio transducer(s) (e.g., microphones) of the mobile device are used to receive the right channel audio signals and which output audio transducer(s) are used to receive the left channel audio signals based on the orientation of the mobile device. Accordingly, the present invention maintains proper stereo separation of input audio signals, regardless of the position in which the mobile device is oriented.

By way of example, one arrangement relates to a method of optimizing audio performance of a mobile device. The method can include detecting an orientation of the mobile device. The method also can include, via a processor, responsive to the mobile device being oriented in a first orientation, dynamically selecting at least a first output audio transducer to output left channel audio signals and dynamically selecting at least a second output audio transducer to output right channel audio signals. The method further can include communicating the left channel audio signals to the first output audio transducer and communicating the right channel audio signals to the second output audio transducer.

In another arrangement, the method can include detecting an orientation of the mobile device. The method also can include, via a processor, responsive to the mobile device being oriented in a first orientation, dynamically selecting at least a first input audio transducer to receive left channel audio signals and dynamically selecting at least a second input audio transducer to a receive right channel audio signals. The method further can include receiving the left channel audio signals from the first input audio transducer and receiving the right channel audio signals from the second input audio transducer.

Another arrangement relates to a mobile device. The mobile device can include an orientation sensor configured to detect an orientation of the mobile device. The mobile device also can include a processor configured to, responsive to the mobile device being oriented in a first orientation, dynamically select at least a first output audio transducer to output left channel audio signals and dynamically select at least a second output audio transducer to output right channel audio signals. The processor also can be configured to communicate the left channel audio signals to the first output audio transducer and communicate the right channel audio signals to the second output audio transducer.

In another arrangement, the mobile device can include an orientation sensor configured to detect an orientation of the mobile device. The mobile device also can include a processor configured to, responsive to the mobile device being oriented in a first orientation, dynamically select at least a first input audio transducer to receive left channel audio signals and dynamically select at least a second input audio transducer to a receive right channel audio signals. The processor also can be configured to receive the left channel audio signals from the first input audio transducer and receive the right channel audio signals from the second input audio transducer.

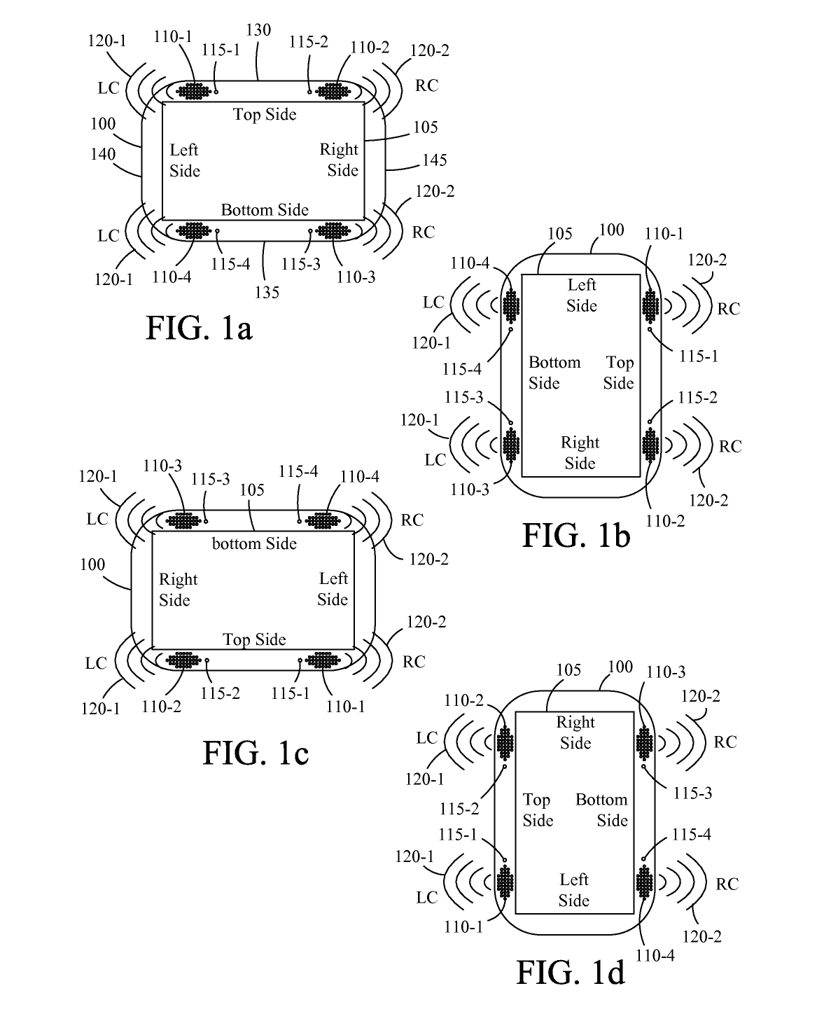

FIGS. 1a-1d depict a front view of a mobile device 100 in various orientations, which are useful for understanding the present invention. The mobile device 100 can be a tablet computer, a smart phone, a mobile gaming device, or any other mobile device that can output audio signals. The mobile device 100 can include a display 105. The display 105 can be a touchscreen, or any other suitable display. The mobile device 100 further can include a plurality of output audio transducers 110 and a plurality of input audio transducers 115.

Referring to FIG. 1a, the output audio transducers 110-1, 110-2 and input audio transducers 115-1, 115-2 can be vertically positioned at, or proximate to, a top side of the mobile device 100, for example at, or proximate to, an upper peripheral edge 130 of the mobile device 100. The output audio transducers 110-3, 110-4 and input audio transducers 115-3, 115-4 can be vertically positioned at, or proximate to, a bottom side of the mobile device 100, for example at, or proximate to, a lower peripheral edge 135 of the mobile device 100. Further, the output audio transducers 110-1, 110-4 and input audio transducers 115-1, 115-4 can be horizontally positioned at, or proximate to, a left side of the mobile device 100, for example at, or proximate to, a left peripheral edge 140 of the mobile device 100. The output audio transducers 110-2, 110-3 and input audio transducers 115-2, 115-3 can be horizontally positioned at, or proximate to, a right side of the mobile device 100, for example at, or proximate to a right peripheral edge 145 of the mobile device 100. In one embodiment, one or more of the output audio transducers 110 or input audio transducers 115 can be positioned at respective corners of the mobile device 100. Each input audio transducers 115 can be positioned approximately near a respective output audio transducer, though this need not be the case.

While using the mobile device 100, a user can orient the mobile device in any desired orientation by rotating the mobile device 100 about an axis perpendicular to the surface of the display 105. For example, FIG. 1a depicts the mobile device 100 in a top side-up landscape orientation, FIG. 1b depicts the mobile device 100 in a left side-up portrait orientation, FIG. 1c depicts the mobile device 100 in a bottom side-up (i.e., top side-down) landscape orientation, and FIG. 1d depicts the mobile device in a right side-up portrait orientation. In FIGS. 1a-1d, respective sides of the display 105 have been identified as top side, right side, bottom side and left side. Notwithstanding, the invention is not limited to these examples. For example, the side of the display 105 indicated as being the left side can be the top side, the side of the display 105 indicated as being the top side can be the right side, the side of the display 105 indicated as being the right side can be the bottom side, and the side of the display 105 indicated as being the bottom side can be the left side.

Moreover, although four output audio transducers are depicted, the present invention can be applied to a mobile device having two output audio transducers, three output audio transducers, or more than four output audio transducers. Similarly, although four input audio transducers are depicted, the present invention can be applied to a mobile device having two input audio transducers, three input audio transducers, or more than four input audio transducers.

Referring to FIG. 1a, when the mobile device 100 is in the top side-up landscape orientation, the mobile device 100 can be configured to dynamically select the output audio transducer 110-1 and/or the output audio transducer 110-4 to output left channel audio signals 120-1 and dynamically select the output audio transducer 110-2 and/or the output audio transducer 110-3 to output right channel audio signals 120-2. Accordingly, when playing audio media, for example audio media from an audio presentation/recording or audio media from a multimedia presentation/recording, the mobile device can communicate left channel audio signals 120-1 to the output audio transducer 110-1 and/or the output audio transducer 110-4 for presentation to the user and communicate right channel audio signals 120-2 to the output audio transducer 110-2 and/or the output audio transducer 110-3 for presentation to the user.

Similarly, the mobile device 100 can be configured to dynamically select the input audio transducer 115-1 and/or the input audio transducer 115-4 to receive left channel audio signals and dynamically select the input audio transducer 115-2 and/or the input audio transducer 115-3 to receive right channel audio signals. Accordingly, when receiving audio media, for example audio media generated by a user or other audio media the user wishes to capture with the mobile device 100, the mobile device can receive left channel audio signals from the input audio transducer 115-1 and/or the input audio transducer 115-4 and receive right channel audio signals from the input audio transducer 115-2 and/or the input audio transducer 115-3.

Referring to FIG. 1b, when the mobile device 100 is in the left side-up portrait orientation, the mobile device 100 can be configured to dynamically select the output audio transducer 110-3 and/or the output audio transducer 110-4 to output left channel audio signals 120-1 and dynamically select the output audio transducer 110-1 and/or the output audio transducer 110-2 to output right channel audio signals 120-2. Accordingly, when playing audio media, the mobile device can communicate left channel audio signals 120-1 to the output audio transducer 110-3 and/or the output audio transducer 110-4 for presentation to the user and communicate right channel audio signals 120-2 to the output audio transducer 110-1 and/or the output audio transducer 110-2 for presentation to the user.

Similarly, the mobile device 100 can be configured to dynamically select the input audio transducer 115-3 and/or the input audio transducer 115-4 to receive left channel audio signals and dynamically select the input audio transducer 115-1 and/or the input audio transducer 115-2 to receive right channel audio signals. Accordingly, when receiving audio media, the mobile device can receive left channel audio signals from the input audio transducer 115-3 and/or the input audio transducer 115-4 and receive right channel audio signals from the input audio transducer 115-1 and/or the input audio transducer 115-2.

Referring to FIG. 1c, when the mobile device 100 is in the bottom side-up landscape orientation, the mobile device 100 can be configured to dynamically select the output audio transducer 110-2 and/or the output audio transducer 110-3 to output left channel audio signals 120-1 and dynamically select the output audio transducer 110-1 and/or the output audio transducer 110-4 to output right channel audio signals 120-2. Accordingly, when playing audio media, the mobile device can communicate left channel audio signals 120-1 to the output audio transducer 110-2 and/or the output audio transducer 110-3 for presentation to the user and communicate right channel audio signals 120-2 to the output audio transducer 110-1 and/or the output audio transducer 110-4 for presentation to the user.

Similarly, the mobile device 100 can be configured to dynamically select the input audio transducer 115-2 and/or the input audio transducer 115-3 to receive left channel audio signals and dynamically select the input audio transducer 115-1 and/or the input audio transducer 115-4 to receive right channel audio signals. Accordingly, when receiving audio media, the mobile device can receive left channel audio signals from the input audio transducer 115-2 and/or the input audio transducer 115-3 and receive right channel audio signals from the input audio transducer 115-1 and/or the input audio transducer 115-4.

Referring to FIG. 1d, when the mobile device 100 is in the top side-up landscape orientation, the mobile device 100 can be configured to dynamically select the output audio transducer 110-1 and/or the output audio transducer 110-2 to output left channel audio signals 120-1 and dynamically select the output audio transducer 110-3 and/or the output audio transducer 110-4 to output right channel audio signals 120-2. Accordingly, when playing audio media, the mobile device can communicate left channel audio signals 120-1 to the output audio transducer 110-1 and/or the output audio transducer 110-2 for presentation to the user and communicate right channel audio signals 120-2 to the output audio transducer 110-3 and/or the output audio transducer 110-4 for presentation to the user.

Similarly, the mobile device 100 can be configured to dynamically select the input audio transducer 115-1 and/or the input audio transducer 115-2 to receive left channel audio signals and dynamically select the input audio transducer 115-3 and/or the input audio transducer 115-4 to receive right channel audio signals. Accordingly, when receiving audio media, the mobile device can receive left channel audio signals from the input audio transducer 115-1 and/or the input audio transducer 115-2 and receive right channel audio signals from the input audio transducer 115-3 and/or the input audio transducer 115-4.

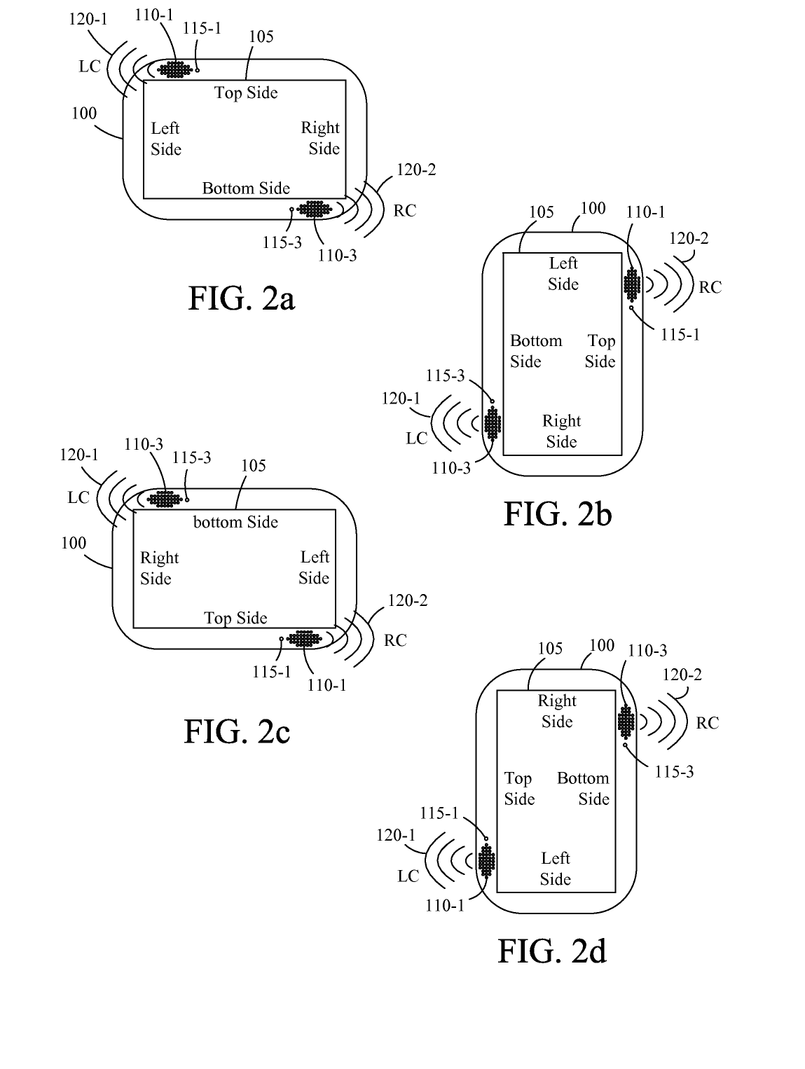

FIGS. 2a-2d depict a front view of another embodiment of the mobile device 100 of FIG. 1, in various orientations. In comparison to FIG. 1, in FIG. 2 the mobile device 100 includes the output audio transducers 110-1, 110-3, but does not include the output audio transducers 110-2, 110-4. Similarly, in FIG. 2 the mobile device 100 includes the input audio transducers 115-1, 115-3, but does not include the input audio transducers 115-2, 115-4.

FIG. 2a depicts the mobile device 100 in a top side-up landscape orientation, FIG. 2b depicts the mobile device 100 in a left side-up portrait orientation, FIG. 2c depicts the mobile device 100 in a bottom side-up (i.e., top side-down) landscape orientation, and FIG. 2d depicts the mobile device in a right side-up portrait orientation.

Referring to FIGS. 2a and 2d, when the mobile device 100 is in the top side-up landscape orientation or in the right side-up portrait orientation, the mobile device 100 can be configured to dynamically select the output audio transducer 110-1 to output left channel audio signals 120-1 and dynamically select the output audio transducer 110-3 to output right channel audio signals 120-2. Accordingly, when playing audio media, the mobile device can communicate left channel audio signals 120-1 to the output audio transducer 110-1 for presentation to the user and communicate right channel audio signals 120-2 to the output audio transducer 110-3 for presentation to the user.

Similarly, the mobile device 100 can be configured to dynamically select the input audio transducer 115-1 to receive left channel audio signals and dynamically select the input audio transducer 115-3 to receive right channel audio signals. Accordingly, when receiving audio media, the mobile device can receive left channel audio signals from the input audio transducer 115-1 and receive right channel audio signals from the input audio transducer 115-3.

Referring to FIGS. 2b and 2c, when the mobile device 100 is in the left side-up portrait orientation or the bottom side-up landscape orientation, the mobile device 100 can be configured to dynamically select the output audio transducer 110-3 to output left channel audio signals 120-1 and dynamically select the output audio transducer 110-1 to output right channel audio signals 120-2. Accordingly, when playing audio media, the mobile device can communicate left channel audio signals 120-1 to the output audio transducer 110-3 for presentation to the user and communicate right channel audio signals 120-2 to the output audio transducer 110-1 for presentation to the user.

Similarly, the mobile device 100 can be configured to dynamically select the input audio transducer 115-3 to receive left channel audio signals and dynamically select the input audio transducer 115-1 to receive right channel audio signals. Accordingly, when receiving audio media, the mobile device can receive left channel audio signals from the input audio transducer 115-3 and receive right channel audio signals from the input audio transducer 115-1.

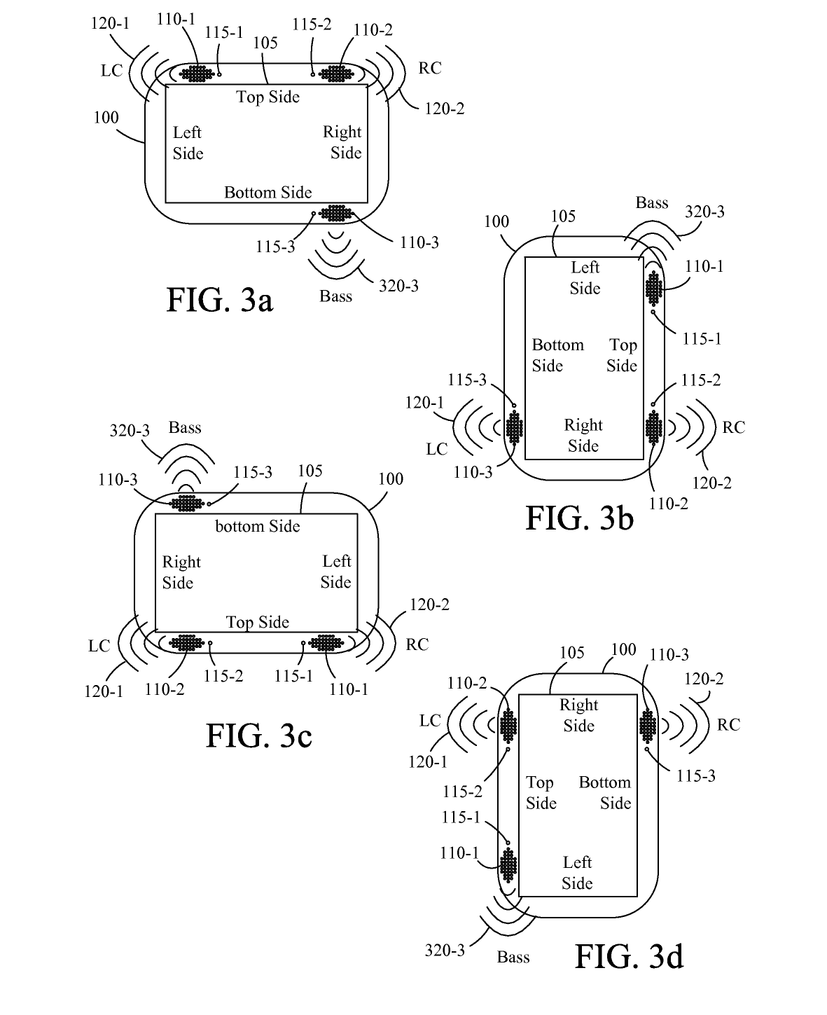

FIGS. 3a-3d depict a front view of another embodiment of the mobile device 100 of FIG. 1, in various orientations. In comparison to FIG. 1, in FIG. 3 the mobile device 100 includes the output audio transducers 110-1, 110-2, 110-3, but does not include the output audio transducer 110-4. Similarly, in FIG. 3 the mobile device 100 includes the input audio transducers 115-1, 115-2, 115-3, but does not include the input audio transducer 115-4.

FIG. 3a depicts the mobile device 100 in a top side-up landscape orientation, FIG. 3b depicts the mobile device 100 in a left side-up portrait orientation, FIG. 3c depicts the mobile device 100 in a bottom side-up (i.e., top side-down) landscape orientation, and FIG. 3d depicts the mobile device in a right side-up portrait orientation.

Referring to FIG. 3a, when the mobile device 100 is in the top side-up landscape orientation, the mobile device 100 can be configured to dynamically select the output audio transducer 110-1 to output left channel audio signals 120-1 and dynamically select the output audio transducer 110-2 to output right channel audio signals 120-2.

Further, the mobile device 100 can be configured to dynamically select the output audio transducer 110-3 to output bass audio signals 320-3. The bass audio signals 320-3 can be presented as a monophonic audio signal. In one arrangement, the bass audio signals 320-3 can comprise portions of the left and/or right channel audio signals 120-1, 120-2 that are below a certain cutoff frequency, for example below 250 Hz, below 200 Hz, below 150 Hz, below 120 Hz, below 100 Hz, below 80 Hz, or the like. In this regard, the bass audio signals 320-3 can be include portions of both the left and right channel audio signals 120-1, 120-2 that are below the cutoff frequency, or portions of either the left channel audio signals 120-1 or right channel audio signals 120-2 that are below the cutoff frequency. A filter, also known in the art as a cross-over, can be applied to filter the left and/or right channel audio signals 120-1, 120-2 to remove signals above the cutoff frequency to produce the bass audio signal 320-3. In another arrangement, the bass audio signals 320-3 can be received from a media application as an audio channel separate from the left and right audio channels 120-1, 120-2.

In one arrangement, the output audio transducers 110-1, 110-2 outputting the respective left and right audio channel signals 120-1, 120-2 can receive the entire bandwidth of the respective audio channels, in which case the bass audio signal 320-3 output by the output audio transducer 110-3 can enhance the bass characteristics of the audio media. In another arrangement, filters can be applied to the left and/or right channel audio channel signals 120-1, 120-2 to remove frequencies below the cutoff frequency.

Accordingly, when playing audio media for presentation to the user, the mobile device can communicate left channel audio signals 120-1 to the output audio transducer 110-1, communicate right channel audio signals 120-2 to the output audio transducer 110-2, and communicate bass audio signals 320-3 to the output audio transducer 110-3.

Similarly, the mobile device 100 can be configured to dynamically select the input audio transducer 115-1 to receive left channel audio signals and dynamically select the input audio transducer 115-2 to receive right channel audio signals. Accordingly, when receiving audio media, for example audio media generated by a user or other audio media the user wishes to capture with the mobile device 100, the mobile device can receive left channel audio signals from the input audio transducer 115-1 and receive right channel audio signals from the input audio transducer 115-2.

Referring to FIG. 3b, when the mobile device 100 is in the left side-up portrait orientation, the mobile device 100 can be configured to dynamically select the output audio transducer 110-3 to output left channel audio signals 120-1, dynamically select the output audio transducer 110-2 to output right channel audio signals 120-2, and dynamically select the output audio transducer 110-1 to output bass audio signals 320-3. Accordingly, when playing audio media for presentation to the user, the mobile device can communicate left channel audio signals 120-1 to the output audio transducer 110-3, communicate right channel audio signals 120-2 to the output audio transducer 110-2 and communicate bass audio signals 320-3 to the output audio transducer 110-1.

Similarly, the mobile device 100 can be configured to dynamically select the input audio transducer 115-3 to receive left channel audio signals and dynamically select the input audio transducer 115-2 to receive right channel audio signals. Accordingly, when receiving audio media, the mobile device can receive left channel audio signals from the input audio transducer 115-3 and receive right channel audio signals from the input audio transducer 115-2.

Referring to FIG. 3c, when the mobile device 100 is in the bottom side-up landscape orientation, the mobile device 100 can be configured to dynamically select the output audio transducer 110-2 to output left channel audio signals 120-1, dynamically select the output audio transducer 110-1 to output right channel audio signals 120-2, and dynamically select the output audio transducer 110-3 to output bass audio signals 320-3. Accordingly, when playing audio media for presentation to the user, the mobile device can communicate left channel audio signals 120-1 to the output audio transducer 110-2, communicate right channel audio signals 120-2 to the output audio transducer 110-1, and output bass audio signals 320-3 to the output audio transducer 110-3.

Similarly, the mobile device 100 can be configured to dynamically select the input audio transducer 115-2 to receive left channel audio signals and dynamically select the input audio transducer 115-1 to receive right channel audio signals. Accordingly, when receiving audio media, the mobile device can receive left channel audio signals from the input audio transducer 115-2 and receive right channel audio signals from the input audio transducer 115-1.

Referring to FIG. 3d, when the mobile device 100 is in the top side-up landscape orientation, the mobile device 100 can be configured to dynamically select the output audio transducer 110-2 to output left channel audio signals 120-1, dynamically select the output audio transducer 110-3 to output right channel audio signals 120-2, and dynamically select the output audio transducer 110-1 to output bass audio signals 320-3. Accordingly, when playing audio media for presentation to the user, the mobile device can communicate left channel audio signals 120-1 to the output audio transducer 110-2, communicate right channel audio signals 120-2 to the output audio transducer 110-3, and communicate bass audio signals 320-3 to the output audio transducer 110-1.

Similarly, the mobile device 100 can be configured to dynamically select the input audio transducer 115-2 to receive left channel audio signals and dynamically select the input audio transducer 115-3 to receive right channel audio signals. Accordingly, when receiving audio media, the mobile device can receive left channel audio signals from the input audio transducer 115-2 and receive right channel audio signals from the input audio transducer 115-3.

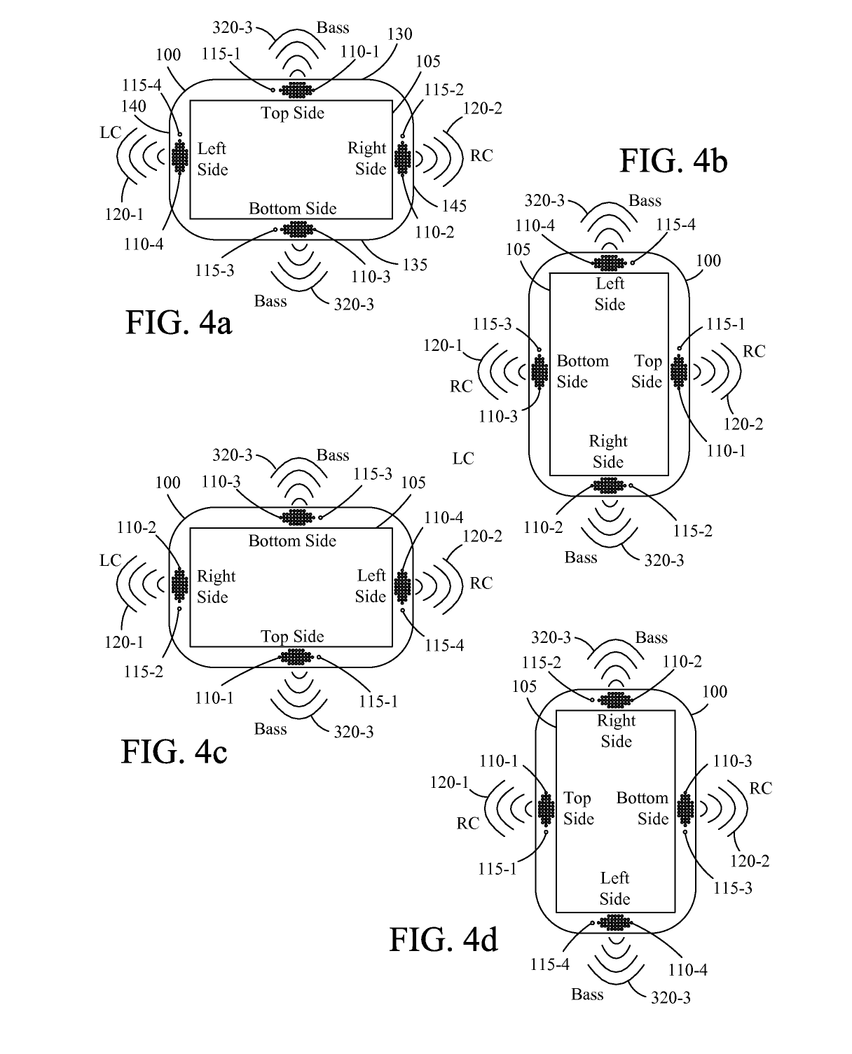

FIGS. 4a-4d depict a front view of another embodiment of the mobile device 100 of FIG. 1, in various orientations. In comparison to FIG. 1, in FIG. 4 the output audio transducers 110 and input audio transducers 115 are positioned at different locations on the mobile device 100. Referring to FIG. 4a, the output audio transducer 110-1 and input audio transducer 115-1 can be vertically positioned at, or proximate to, a top side of the mobile device 100, for example at, or proximate to, an upper peripheral edge 130 of the mobile device 100. The output audio transducer 110-3 and input audio transducer 115-3 can be vertically positioned at, or proximate to, a bottom side of the mobile device 100, for example at, or proximate to, a lower peripheral edge 135 of the mobile device 100. Further, the output audio transducers 110-1, 110-3 and input audio transducers 115-1, 115-3 horizontally can be approximately centered with respect to the right and left sides of the mobile device. Each of the input audio transducers 115-1, 115-3 can be positioned approximately near a respective output audio transducer 110-1, 110-3, though this need not be the case.

The output audio transducer 110-2 and input audio transducer 115-2 can be horizontally positioned at, or proximate to, a right side of the mobile device 100, for example at, or proximate to, a right peripheral edge 145 of the mobile device 100. The output audio transducer 110-4 and input audio transducer 115-4 can be horizontally positioned at, or proximate to, a left side of the mobile device 100, for example at, or proximate to, a left peripheral edge 140 of the mobile device 100. Further, the output audio transducers 110-2, 110-4 and input audio transducers 115-2, 115-4 vertically can be approximately centered with respect to the top and bottom sides of the mobile device. Each of the input audio transducers 115-2, 115-4 can be positioned approximately near a respective output audio transducer 110-2, 110-4, though this need not be the case.

FIG. 4a depicts the mobile device 100 in a top side-up landscape orientation, FIG. 4b depicts the mobile device 100 in a left side-up portrait orientation, FIG. 4c depicts the mobile device 100 in a bottom side-up (i.e., top side-down) landscape orientation, and FIG. 4d depicts the mobile device in a right side-up portrait orientation.

Referring to FIG. 4a, when the mobile device 100 is in the top side-up landscape orientation, the mobile device 100 can be configured to dynamically select the output audio transducer 110-4 to output left channel audio signals 120-1 and dynamically select the output audio transducer 110-2 to output right channel audio signals 120-2. Accordingly, when playing audio media, the mobile device can communicate left channel audio signals 120-1 to the output audio transducer 110-4 for presentation to the user and communicate right channel audio signals 120-2 to the output audio transducer 110-2 for presentation to the user. Further, the mobile device 100 can be configured to dynamically select the output audio transducers 110-1, 110-3 to output bass audio signals 320-3.

Similarly, the mobile device 100 can be configured to dynamically select the input audio transducer 115-4 to receive left channel audio signals and dynamically select the input audio transducer 115-2 to receive right channel audio signals. Accordingly, when receiving audio media, the mobile device can receive left channel audio signals from the input audio transducer 115-4 and receive right channel audio signals from the input audio transducer 115-2.

Referring to FIG. 4b, when the mobile device 100 is in the left side-up portrait orientation, the mobile device 100 can be configured to dynamically select the output audio transducer 110-3 to output left channel audio signals 120-1 and dynamically select the output audio transducer 110-1 to output right channel audio signals 120-2. Accordingly, when playing audio media, the mobile device can communicate left channel audio signals 120-1 to the output audio transducer 110-3 for presentation to the user and communicate right channel audio signals 120-2 to the output audio transducer 110-1 for presentation to the user. Further, the mobile device 100 can be configured to dynamically select the output audio transducers 110-2, 110-4 to output bass audio signals 320-3.

Similarly, the mobile device 100 can be configured to dynamically select the input audio transducer 115-3 to receive left channel audio signals and dynamically select the input audio transducer 115-1 to receive right channel audio signals. Accordingly, when receiving audio media, the mobile device can receive left channel audio signals from the input audio transducer 115-3 and receive right channel audio signals from the input audio transducer 115-1.

Referring to FIG. 4c, when the mobile device 100 is in the bottom side-up landscape orientation, the mobile device 100 can be configured to dynamically select the output audio transducer 110-2 to output left channel audio signals 120-1 and dynamically select the output audio transducer 110-4 to output right channel audio signals 120-2. Accordingly, when playing audio media, the mobile device can communicate left channel audio signals 120-1 to the output audio transducer 110-2 for presentation to the user and communicate right channel audio signals 120-2 to the output audio transducer 110-4 for presentation to the user. Further, the mobile device 100 can be configured to dynamically select the output audio transducers 110-1, 110-3 to output bass audio signals 320-3.

Similarly, the mobile device 100 can be configured to dynamically select the input audio transducer 115-2 to receive left channel audio signals and dynamically select the input audio transducer 115-4 to receive right channel audio signals. Accordingly, when receiving audio media, the mobile device can receive left channel audio signals from the input audio transducer 115-2 and receive right channel audio signals from the input audio transducer 115-4.

Referring to FIG. 4d, when the mobile device 100 is in the right side-up portrait orientation, the mobile device 100 can be configured to dynamically select the output audio transducer 110-1 to output left channel audio signals 120-1 and dynamically select the output audio transducer 110-3 to output right channel audio signals 120-2. Accordingly, when playing audio media, the mobile device can communicate left channel audio signals 120-1 to the output audio transducer 110-1 for presentation to the user and communicate right channel audio signals 120-2 to the output audio transducer 110-3 for presentation to the user. Further, the mobile device 100 can be configured to dynamically select the output audio transducers 110-2, 110-4 to output bass audio signals 320-3.

Similarly, the mobile device 100 can be configured to dynamically select the input audio transducer 115-1 to receive left channel audio signals and dynamically select the input audio transducer 115-3 to receive right channel audio signals. Accordingly, when receiving audio media, the mobile device can receive left channel audio signals from the input audio transducer 115-1 and receive right channel audio signals from the input audio transducer 115-3.

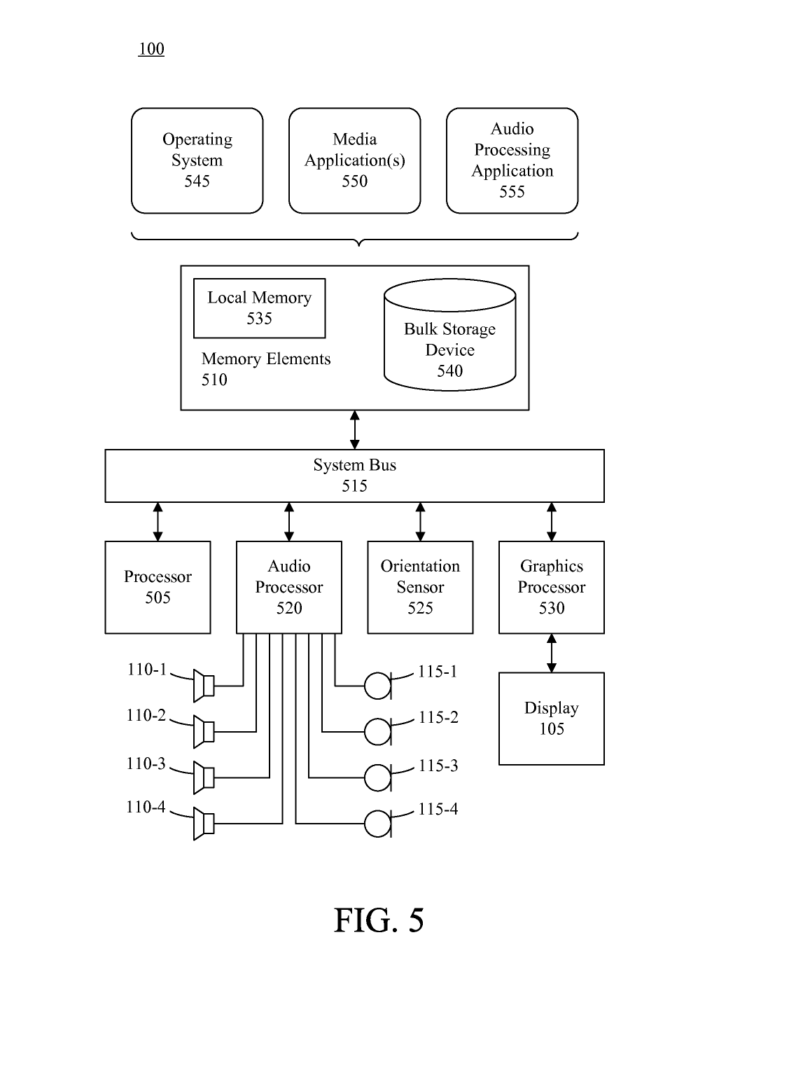

FIG. 5 is a block diagram of the mobile device 100 that is useful for understanding the present arrangements. The mobile device 100 can include at least one processor 505 coupled to memory elements 510 through a system bus 515. The processor 505 can comprise for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions.

In one arrangement, the processor 505 can perform the audio processing functions described herein. In another arrangement, an audio processor 520 can be coupled to memory elements 510 through a system bus 515, and tasked with performing at least a portion of the audio processing functions. For example, the audio processor 520 can perform digital to analog (A/D) conversion of audio signals, perform analog to digital (D/A) conversion of audio signals, select which output audio transducers 110 are to output various audio signals, select which input audio transducers 115 are to receive various audio signals, and the like. In this regard, the audio processor 520 can be communicatively linked to the output audio transducers 110 and the input audio transducers 115, either directly or via an intervening controller or bus.

Further, the audio processor 520 also can be coupled to the processor 505 and an orientation sensor 525 via the system bus 515. The orientation sensor 525 can comprise one or more accelerometers, or any other sensors or devices that may be used to detect the orientation of the mobile device 100 (e.g., top side-up, left side-up, bottom side-up and right side-up).

The mobile device also can include the display 105, which can be coupled directly to the system bus 515, coupled to the system bus 515 via a graphic processor 530, or coupled to the system bus 515 between any other suitable input/output (I/O) controller. Additional devices also can be coupled to the mobile device via the system bus 515 and/or intervening I/O controllers, and the invention is not limited in this regard.

The mobile device 100 can store program code within memory elements 510. The processor 505 can execute the program code accessed from the memory elements 510 via system bus 515. In one aspect, for example, the mobile device 100 can be implemented as tablet computer, smart phone or gaming device that is suitable for storing and/or executing program code. It should be appreciated, however, that the mobile device 100 can be implemented in the form of any system comprising a processor and memory that is capable of performing the functions described within this specification.

The memory elements 510 can include one or more physical memory devices such as, for example, local memory 535 and one or more bulk data storage devices 540. Local memory 535 refers to random access memory or other non-persistent memory device(s) generally used during actual execution of the program code. A bulk data storage device 540 can be implemented as a hard disk drive (HDD), flash memory (e.g., a solid state drive (SSD)), or other persistent data storage device. The mobile device 100 also can include one or more cache memories (not shown) that provide temporary storage of at least some program code in order to reduce the number of times program code must be retrieved from the bulk storage device 540 during execution.

As pictured in FIG. 5, the memory elements 510 can store an operating system 545, one or more media applications 550, and an audio processing application 555, each of which can be implemented as computer-readable program code, which may be executed by the processor 505 and/or the audio processor 520 to perform the functions described herein. In one arrangement, in lieu of, or in addition to, the audio processing application 555, audio processing firmware can be stored within the mobile device 100, for example within memory elements of the audio processor 520. In this regard, the audio processing firmware can be stored in read-only memory (ROM), erasable programmable read only memory (EPROM), electrically erasable programmable read-only memory (EEPROM or Flash ROM), or the like.

In operation, a user can execute a media application 550 on the mobile device to experience audio media. As noted, the audio media can be contained in a multimedia presentation, an audio presentation, or the like. The audio processor 520 (or processor 505) can receive one or more signals from the orientation sensor 525 indicating the present orientation of the mobile device 100. Based on the present orientation, the audio processor 520 (or processor 505) can dynamically select which output audio transducer(s) 110 is/are to be used to output left channel audio signals generated by the audio media and which output audio transducer(s) 110 is/are to be used to output right channel audio signals generated by the audio media, for example as described herein. Optionally, the audio processor 520 (or processor 505) also can dynamically select which output audio transducer(s) 110 is/are to be used to output bass audio. In one arrangement, the audio processor 520 can implement filtering on the right and left audio signals to generate the bass audio signals. In another arrangement, the media application 550 can provide the bass audio signals as an audio channel separate from the left and right audio channels. Further, the audio processor 520 (or processor 505) can dynamically select which input audio transducer(s) 115 is/are to be used to receive left channel audio signals and which input audio transducer(s) 110 is/are to be used to receive right channel audio signals, for example as described herein.

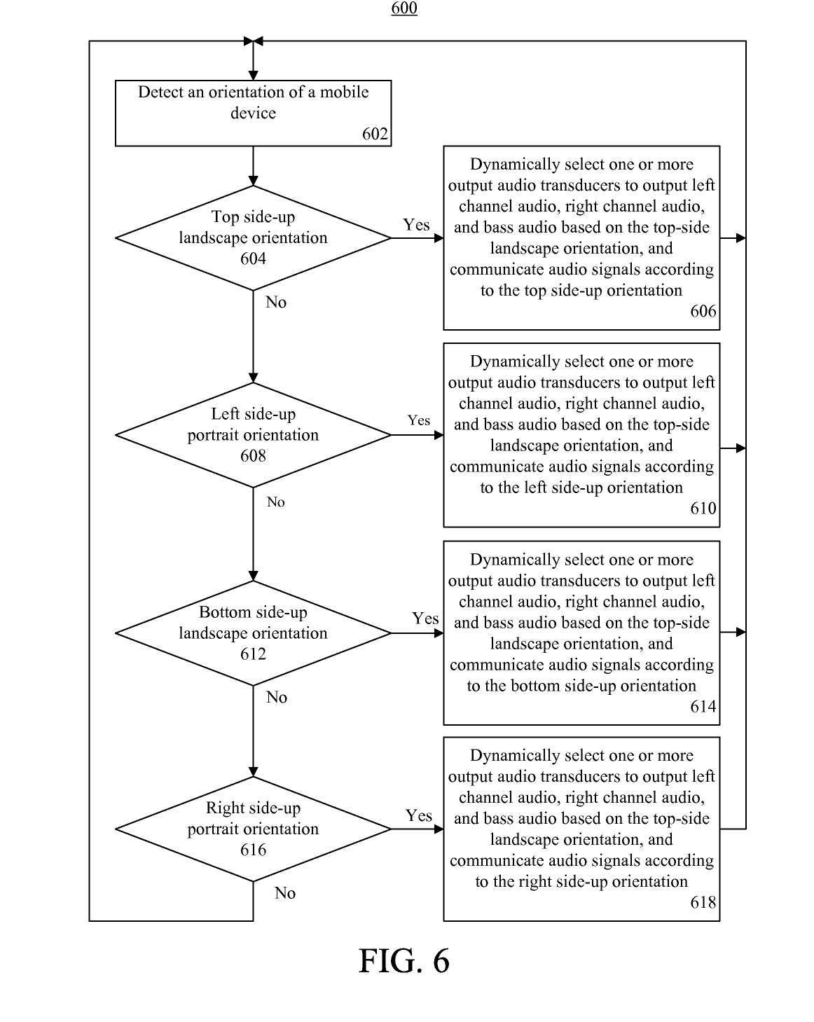

FIG. 6 is a flowchart illustrating a method 600 that is useful for understanding the present arrangements. At step 602, an orientation of the communication device can be detected. At decision box 604, if the mobile device is in a top side-up landscape orientation, at step 606 the mobile device can dynamically select one or more output audio transducers to output left channel audio signals, right channel audio signals, and/or bass audio based on the top-side landscape orientation, and communicate audio signals to the respective output audio transducers according to the top side-up landscape orientation. For example, the output audio signals can be output as described with reference to FIGS. 1a, 2a, 3a and 4a.

At decision box 608, if the mobile device is in a left side-up portrait orientation, at step 610 the mobile device can dynamically select one or more output audio transducers to output left channel audio signals, right channel audio signals, and/or bass audio based on the left-side portrait orientation, and communicate audio signals to the respective output audio transducers according to the left side-up portrait orientation. For example, the output audio signals can be output as described with reference to FIGS. 1b, 2b, 3b and 4b.

At decision box 612, if the mobile device is in a bottom side-up landscape orientation, at step 614 the mobile device can dynamically select one or more output audio transducers to output left channel audio signals, right channel audio signals, and/or bass audio based on the bottom-side landscape orientation, and communicate audio signals to the respective output audio transducers according to the bottom side-up landscape orientation. For example, the output audio signals can be output as described with reference to FIGS. 1c, 2c, 3c and 4c.

At decision box 616, if the mobile device is in a right side-up portrait orientation, at step 618 the mobile device can dynamically select one or more output audio transducers to output left channel audio signals, right channel audio signals, and/or bass audio based on the right-side portrait orientation, and communicate audio signals to the respective output audio transducers according to the right side-up portrait orientation. For example, the output audio signals can be output as described with reference to FIGS. 1d, 2d, 3d and 4d.

The process can return to step 602 when a change of orientation of the mobile device is detected.

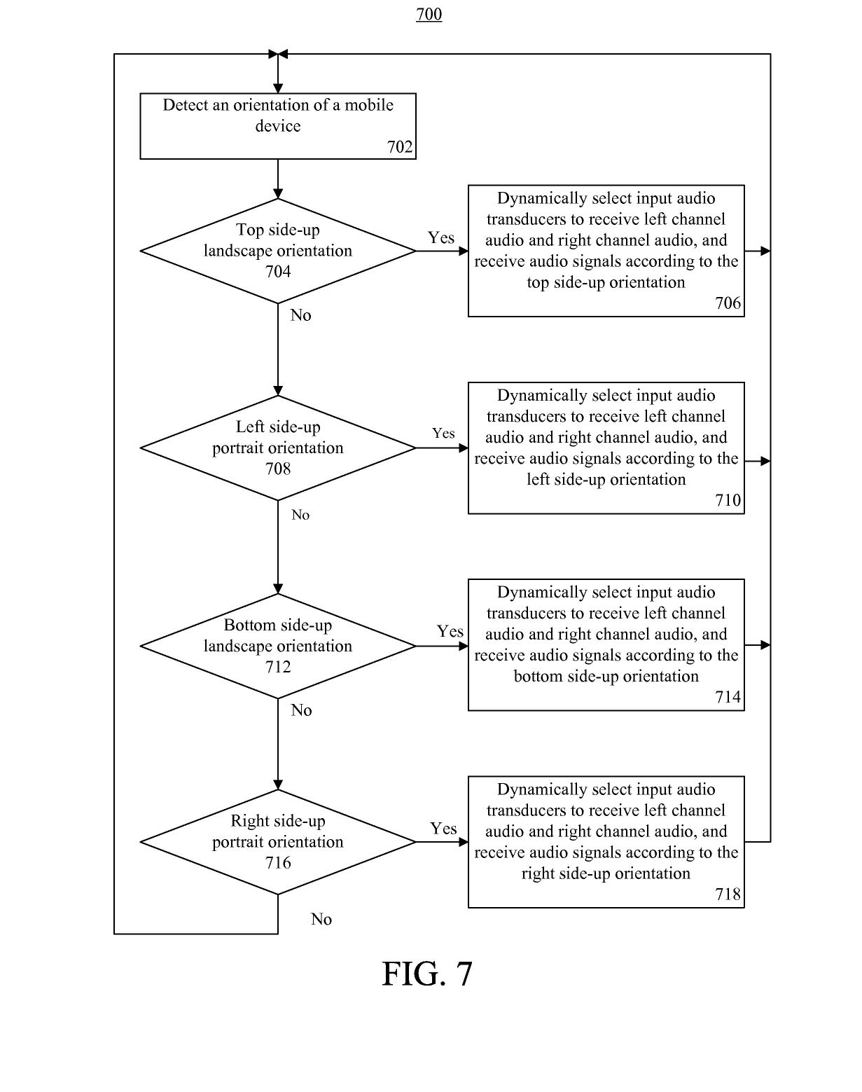

FIG. 7 is a flowchart illustrating a method 700 that is useful for understanding the present arrangements. At step 702, an orientation of the communication device can be detected. At decision box 704, if the mobile device is in a top side-up landscape orientation, at step 706 the mobile device can dynamically select one or more input audio transducers to receive left channel audio signals and right channel audio signals based on the top-side landscape orientation, and receive audio signals from the respective input audio transducers according to the top side-up landscape orientation. For example, the input audio signals can be received as described with reference to FIGS. 1a, 2a, 3a and 4a.

At decision box 708, if the mobile device is in a left side-up portrait orientation, at step 710 the mobile device can dynamically select one or more input audio transducers to receive left channel audio signals and right channel audio signals based on the left-side portrait orientation, and receive audio signals from the respective input audio transducers according to the left side-up portrait orientation. For example, the input audio signals can be received as described with reference to FIGS. 1b, 2b, 3b and 4b.

At decision box 712, if the mobile device is in a bottom side-up landscape orientation, at step 714 the mobile device can dynamically select one or more input audio transducers to receive left channel audio signals and right channel audio signals based on the bottom side-up landscape, and receive audio signals from the respective input audio transducers according to the bottom side-up landscape. For example, the input audio signals can be received as described with reference to FIGS. 1c, 2c, 3c and 4c.

At decision box 716, if the mobile device is in a right side-up portrait orientation, at step 718 the mobile device can dynamically select one or more input audio transducers to receive left channel audio signals and right channel audio signals based on the right side-up portrait orientation, and receive audio signals from the respective input audio transducers according to right side-up portrait orientation. For example, the input audio signals can be received as described with reference to FIGS. 1d, 2d, 3d and 4d.

The process can return to step 202 when a change of orientation of the mobile device is detected.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The present invention also can be embedded in a computer-readable storage device, such as a computer program product or other data programs storage device, readable by a machine, tangibly embodying a program of instructions executable by the machine to perform methods and processes described herein. The computer-readable storage device can be, for example, non-transitory in nature. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of optimizing audio performance of a mobile device, comprising:
detecting an orientation of the mobile device;
via a processor, responsive to the mobile device being oriented in a first orientation, dynamically selecting at least a first output audio transducer to output left channel audio signals and dynamically selecting at least a second output audio transducer to output right channel audio signals; and
communicating the left channel audio signals to the first output audio transducer and communicating the right channel audio signals to the second output audio transducer.

2. The method of claim 1, further comprising:
detecting a change in the orientation of the mobile device;
responsive to the mobile device being oriented in a second orientation, dynamically selecting at least the first output audio transducer to output the right channel audio signals and dynamically selecting at least the second output audio transducer to output the left channel audio signals; and
communicating the right channel audio signals to the first output audio transducer and communicating the left channel audio signals to the second output audio transducer.

3. The method of claim 1, further comprising:
detecting a change in the orientation of the mobile device;
responsive to the mobile device being oriented in a second orientation, dynamically selecting at least the first output audio transducer to output the right channel audio signals, and dynamically selecting at least a third output audio transducer to output the left channel audio signals; and
communicating the right channel audio signals to the first output audio transducer, and communicating the left channel audio signals to the third output audio transducer.

4. The method of claim 1, further comprising:
responsive to the mobile device oriented in the first orientation, dynamically selecting at least a third output audio transducer to output bass audio signals.

5. The method of claim 4, further comprising:
detecting a change in the orientation of the mobile device;
responsive to the mobile device being oriented in a second orientation, dynamically selecting at least the first output audio transducer to output the right channel audio signals, dynamically selecting at least the second output audio transducer to output the bass audio signals, and dynamically selecting at least the third output audio transducer to output the left channel audio signals; and
communicating the right channel audio signals to the first output audio transducer, communicating the bass audio signals to the second output audio transducer, and communicating the left channel audio signals to the third output audio transducer.

6. The method of claim 1, further comprising:
detecting a change in the orientation of the mobile device;
responsive to the mobile device being oriented in a second orientation, dynamically selecting at least a third output audio transducer to output the right channel audio signals and dynamically selecting at least a fourth output audio transducer to output the left channel audio signals; and
communicating the right channel audio signals to the third output audio transducer and communicating the left channel audio signals to the fourth output audio transducer.

7. The method of claim 6, further comprising:
responsive to the mobile device being oriented in the second orientation, dynamically selecting the first output audio transducer to output bass audio signals and dynamically selecting the second output audio transducer to output the bass audio signals; and
communicating the bass audio signals to the first output audio transducer and the second output audio transducer.

8. The method of claim 7, further comprising:
responsive to the mobile device being oriented in the first orientation, dynamically selecting the third output audio transducer to output the bass audio signals and dynamically selecting the fourth output audio transducer to output the bass audio signals; and
communicating the bass audio signals to both the third output audio transducer and the fourth output audio transducer.

9. A method of optimizing audio performance of a mobile device, comprising:
detecting an orientation of the mobile device;
via a processor, responsive to the mobile device being oriented in a first orientation, dynamically selecting at least a first input audio transducer to receive left channel audio signals and dynamically selecting at least a second input audio transducer to a receive right channel audio signals; and
receiving the left channel audio signals from the first input audio transducer and receiving the right channel audio signals from the second input audio transducer.

10. The method of claim 9, further comprising:
detecting a change in the orientation of the mobile device;
responsive to the mobile device being oriented in a second orientation, dynamically selecting at least the first input audio transducer to receive the right channel audio signals and dynamically selecting at least the second input audio transducer to receive the left channel audio signals; and
receiving the right channel audio signals from the first input audio transducer and receiving the left channel audio signals from the second input audio transducer.

11. The method of claim 9, further comprising:
detecting a change in the orientation of the mobile device;
responsive to the mobile device being oriented in a second orientation, dynamically selecting at least the first input audio transducer to receive the right channel audio signals, and dynamically selecting at least a third input audio transducer to receive the left channel audio signals; and
receiving the right channel audio signals from the first input audio transducer, and receiving the left channel audio signals from the third input audio transducer.

12. The method of claim 9, further comprising:
detecting a change in the orientation of the mobile device;
responsive to the mobile device being oriented in a second orientation, dynamically selecting at least a third input audio transducer to receive the right channel audio signals and dynamically selecting at least a fourth input audio transducer to receive the left channel audio signals; and
receiving the right channel audio signals from the third input audio transducer and receiving the left channel audio signals from the fourth input audio transducer.

13. A mobile device, comprising:
an orientation sensor configured to detect an orientation of the mobile device;
a processor configured to:
responsive to the mobile device being oriented in a first orientation, dynamically select at least a first output audio transducer to output left channel audio signals and dynamically select at least a second output audio transducer to output right channel audio signals; and
communicate the left channel audio signals to the first output audio transducer and communicate the right channel audio signals to the second output audio transducer.

14. The mobile device of claim 13, wherein:
the orientation sensor configured to detect a change in the orientation of the mobile device; and
the processor is configured to:
responsive to the mobile device being oriented in a second orientation, dynamically select at least the first output audio transducer to output the right channel audio signals and dynamically select at least the second output audio transducer to output the left channel audio signals; and
communicate the right channel audio signals to the first output audio transducer and communicate the left channel audio signals to the second output audio transducer.

15. The mobile device of claim 13, wherein:
the orientation sensor configured to detect a change in the orientation of the mobile device; and
the processor is configured to:
responsive to the mobile device being oriented in a second orientation, dynamically select at least the first output audio transducer to output the right channel audio signals, and dynamically select at least a third output audio transducer to output the left channel audio signals; and
communicate the right channel audio signals to the first output audio transducer, and communicate the left channel audio signals to the third output audio transducer.

16. The mobile device of claim 13, wherein the processor is configured to:
responsive to the mobile device oriented in the first orientation, dynamically select at least a third output audio transducer to output bass audio signals.

17. The mobile device of claim 16, wherein:
the orientation sensor configured to detect a change in the orientation of the mobile device; and
the processor is configured to:
responsive to the mobile device being oriented in a second orientation, dynamically select at least the first output audio transducer to output the right channel audio signals, dynamically select at least the second output audio transducer to output the bass audio signals, and dynamically select at least the third output audio transducer to output the left channel audio signals; and
communicate the right channel audio signals to the first output audio transducer, communicate the bass audio signals to the second output audio transducer, and communicate the left channel audio signals to the third output audio transducer.

18. The mobile device of claim 13, wherein:
the orientation sensor configured to detect a change in the orientation of the mobile device; and
the processor is configured to:
responsive to the mobile device being oriented in a second orientation, dynamically select at least a third output audio transducer to output the right channel audio signals and dynamically select at least a fourth output audio transducer to output the left channel audio signals; and
communicate the right channel audio signals to the third output audio transducer and communicate the left channel audio signals to the fourth output audio transducer.

19. The mobile device of claim 18, wherein the processor is configured to:
responsive to the mobile device being oriented in the second orientation, dynamically select the first output audio transducer to output bass audio signals and dynamically select the second output audio transducer to output the bass audio signals; and
communicate the bass audio signals to the first output audio transducer and the second output audio transducer.

20. The mobile device of claim 19, wherein the processor is configured to:
responsive to the mobile device being oriented in the first orientation, dynamically select the third output audio transducer to output the bass audio signals and dynamically select the fourth output audio transducer to output the bass audio signals; and
communicate the bass audio signals to both the third output audio transducer and the fourth output audio transducer.

21. A mobile device, comprising:
an orientation sensor configured to detect an orientation of the mobile device;
a processor configured to:
responsive to the mobile device being oriented in a first orientation, dynamically select at least a first input audio transducer to receive left channel audio signals and dynamically select at least a second input audio transducer to a receive right channel audio signals; and
receive the left channel audio signals from the first input audio transducer and receive the right channel audio signals from the second input audio transducer.

22. The mobile device of claim 21, wherein:
the orientation sensor configured to detect a change in the orientation of the mobile device; and
the processor is configured to:
responsive to the mobile device being oriented in a second orientation, dynamically select at least the first input audio transducer to receive the right channel audio signals and dynamically select at least the second input audio transducer to receive the left channel audio signals; and
receive the right channel audio signals from the first input audio transducer and receive the left channel audio signals from the second input audio transducer.

23. The mobile device of claim 21 wherein:
the orientation sensor configured to detect a change in the orientation of the mobile device; and
the processor is configured to:
responsive to the mobile device being oriented in a second orientation, dynamically select at least the first input audio transducer to receive the right channel audio signals, and dynamically select at least a third input audio transducer to receive the left channel audio signals; and
receive the right channel audio signals from the first input audio transducer, and receive the left channel audio signals from the third input audio transducer.

24. The mobile device of claim 21, wherein:
the orientation sensor configured to detect a change in the orientation of the mobile device; and
the processor is configured to:
responsive to the mobile device being oriented in a second orientation, dynamically select at least a third input audio transducer to receive the right channel audio signals and dynamically select at least a fourth input audio transducer to receive the left channel audio signals; and
receive the right channel audio signals from the third input audio transducer and receive the left channel audio signals from the fourth input audio transducer.
